(19) United States
(12) Patent Application Publication
(10) Pub. No.: US 2026/0236329 A1
(43) Pub. Date: Aug. 13, 2026

(54) APPLICATION PROGRAMMING INTERFACES WITH FACADE MODEL

(71) Applicant: Wells Fargo Bank, N.A., San Francisco, CA (US)

(72) Inventors: John Bruno, Scottsdale, AZ (US); Udaya K. Isampalli, Tega Cay, SC (US); Joel Co, Phoenix, AZ (US)

(21) Appl. No.: 19/052,854

(22) Filed: Feb. 13, 2025

(51) Int. Cl. G06F 9/54; G06Q 40/02

(52) U.S. Cl. CPC G06F 9/541; G06Q 40/02

(57) ABSTRACT

Example modular components within a financial services platform can include a processor executing instructions to generate at least one API facade using a domain-specific language associated with a predefined framework. The API facade is stored in a centralized developer portal, enabling access and seamless integration into the platform. A core application programming interface layer exposes platform functionalities, facilitating interaction between the API facade and external systems. The examples can further include an API façade engine operably coupled to the core API layer, configured to translate the exposed functionalities to conform to at least one of multiple competing API standards. This architecture streamlines the development, deployment, and interoperability of financial services across diverse applications and platforms, enhancing scalability, adaptability, and user experience.

### BACKGROUND

Financial services platforms have become widely used tools for managing complex financial operations, including treasury management, payments, cash flow analysis, and international banking. Traditionally, these platforms have been constructed as monolithic applications, which consolidate a wide array of features within a singular architecture. While this design enables centralized functionality, it often results in unintended limitations, including prolonged development cycles, rigid system architectures, and difficulty in responding to evolving customer needs. Furthermore, monolithic platforms can have the effect of isolating product features within silos, leading to fragmented user experiences and inefficiencies in workflow execution. As user expectations for seamless, personalized, and dynamic interactions grow, the limitations of these traditional architectures can present challenges for financial institutions seeking to remain competitive.

Concurrently, the widespread adoption of Application Programming Interface (API)-driven systems to enable interoperability between financial institutions, FinTech platforms, and third-party providers has introduced additional complexities. The financial services industry lacks a unified API standard, with organizations needing to support multiple competing specifications, such as Financial Data Exchange (FDX), Banking Industry Architecture Network (BIAN), and Payment Services Directive 2 (PSD2). Each standard imposes distinct requirements, including differing authentication methods, data models, and interaction protocols. This lack of a unified standard necessitates the development of separate APIs or gateways for each standard, increasing development costs, operational complexity, and maintenance burdens. Moreover, the possible emergence of new API standards exacerbates these challenges, as organizations must regularly update and adapt their systems to maintain compliance and interoperability.

### SUMMARY

Embodiments of the present disclosure relate to a system and method for modernizing financial services platforms by leveraging an advanced API management framework, a centralized marketplace, and dynamic API facades. The system is configured to generate and manage APIs that expose financial services platform functionalities in a standardized manner while adapting to diverse external system requirements. These APIs can be used by various client applications, including but not limited to micro frontends (MFEs), third-party applications, and internal enterprise systems. By facilitating modular API development and deployment, the system addresses the inefficiencies of monolithic applications, enabling faster development cycles, improved flexibility, and an adaptive integration experience while maintaining security, reliability, and compliance with industry regulations.

The system further includes a core application programming interface (API) layer configured to expose functionalities of the financial services platform in a structured and consistent manner. This core API layer provides a standardized mechanism for enabling secure interaction between the financial services platform and external applications, whether they be MFEs, traditional web applications, mobile applications, or third-party enterprise systems. An API facade engine, operably coupled to the core API layer and part of the control messaging facility, is configured to dynamically translate the functionalities exposed by the core API layer to conform to one or more of a plurality of competing API standards. This enables seamless interoperability across financial and regulatory ecosystems, such as those adhering to FDX, BIAN, or PSD2 standards. Additionally, the API facade engine supports the curation of specific API functionalities to align with external system requirements, creating tailored interfaces that streamline integration while ensuring compliance and security. By abstracting the complexities of various API standards, the system provides a flexible and scalable approach to financial services integration, allowing organizations to expose the right APIs based on the intended use case.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example experience platform designed to generate, manage, and integrate APIs within a financial services platform.

FIG. 2 shows example logical components of a server device of the platform of FIG. 1.

FIG. 3 shows an embodiment of a user interface for a marketplace module of FIG. 2.

FIG. 4 shows example logical components of an API façade engine of FIG. 2.

FIG. 5 shows an interconnection between a core API layer and a façade layer publisher view of FIG. 4.

FIG. 6 depicts an architecture diagram illustrating process flows within the experience platform of FIG. 1 for managing both product requests and client requests.

FIG. 7 depicts an architecture diagram illustrating the interconnection of an API gateway, a data façade, and core banking APIs of FIGS. 5 and 6.

FIG. 8 shows an example of a core banking API format.

FIG. 9 shows an example of an FDX-standard API response format.

FIG. 10 shows an example of a PSD2-standard API response format.

FIG. 11 shows an example of a BIAN-standard API response format.

FIG. 12 shows a method for managing modular components within the platform of FIG. 1.

FIG. 13 shows example physical components of the server device of FIG. 1.

### DETAILED DESCRIPTION

The present disclosure generally relates to systems and methods for modernizing financial services platforms by providing a unified application programming interface (API) framework with a facade engine to enable interoperability across multiple API standards.

Financial services platforms provide products and services that enable users, developers, and team members to incorporate financial functionalities into various software environments. These platforms support complex operations such as treasury management, payments, cash flow, and loan or credit management, serving a wide range of professionals, including CFOs, controllers, accounts payable and receivable departments, and treasury teams. Products and services offered by such platforms may include tools for daily cash management, international banking, trade services, payroll, invoicing, and modern capabilities such as real-time visibility into account balances, customizable reporting, analytics, and fraud detection. However, these platforms often face challenges in delivering personalized and scalable user experiences due to reliance on legacy systems that lack the flexibility to adapt to evolving technological requirements and user demands.

A significant challenge with traditional financial services platforms is their reliance on siloed and monolithic architectures. Features within these platforms are often isolated and tied to legacy web applications, making it difficult for users and developers to integrate platform functionalities into other software systems, such as third-party platforms or embedded applications. These architectures limit the ability of users to seamlessly access or request financial products and services within diverse environments. Additionally, development dependencies within monolithic systems lead to prolonged cycles for introducing new features, which hinders the platform's responsiveness to user demands and industry changes. This fragmentation and inflexibility result in reduced usability, prolonged onboarding processes for new services, and limited self-service options for clients who need efficient ways to integrate financial capabilities into their respective workflows.

To address these challenges, the present concept introduces a modular architecture combining generated API facades targeted to specific use cases and standards, along with a robust API management framework. The platform supports a self-service product catalog that allows users, developers, and team members to browse, request, and fulfill product requests tailored to their organizational needs. These requests can relate to onboarding financial capabilities such as instant payment APIs, account balance sharing, or transaction data integrations with third-party accounting software. The modular architecture enables the dynamic generation of API facades, which align with specific operational and regulatory needs, allowing seamless integration into external systems, internal portals, or third-party platforms.

The API management framework, including an API facade engine, can complement the API facade architecture by translating core functionalities into multiple API standards, such as FDX, BIAN, PSD2, among others, to ensure interoperability across diverse systems. This enables the platform to deliver capabilities through curated API facades that are tailored to align with specific use cases and industry standards. By supporting a structured API-driven approach, the platform empowers users to self-service their onboarding and operational processes, including the automation of due diligence, know-your-customer (KYC) requirements, anti-money laundering (AML) protocols, and risk assessments.

The Developer Portal can enable the curation, storage, and versioning of API facades, allowing for efficient reuse and alignment of these interfaces with user entitlements and consent settings. For example, API facades supporting credit underwriting, wire approvals, account navigation, and administrative workflows can be tailored to specific user needs based on their roles and entitlements stored in the identity management framework. The API facades can be accessed through the Developer Portal, enabling their integration into external third-party platforms or directly into internal servicing and client-facing portals.

The platform can also include intelligent mechanisms to surface contextual insights and relevant product offerings to users. For example, the platform can identify potential benefits for a prospective client and surface suggestions for API facade access or financial capabilities such as instant payments, aligned with their use case and industry. Automated or semi-automated processes ensure approval and fulfillment of these requests, leveraging KYC, AML, and regulatory frameworks. The modular design accelerates onboarding processes, allowing users to integrate financial services seamlessly into their workflows, whether through SDK/API integrations, embedded systems, or internal servicing portals.

Embodiments of the present disclosure are rooted in computer technology, addressing specific technical challenges associated with modernizing financial services platforms. These embodiments focus on overcoming inefficiencies inherent in monolithic architectures by introducing a modular architecture centered on APIs. Traditional platforms face fragmented user workflows, prolonged development cycles, and difficulties integrating diverse system components, particularly when interacting with varying API standards. The present concept provides a specific technological solution by generating APIs using a domain-specific language, storing them in a centralized marketplace for efficient versioning and deployment, and integrating them into a platform supported by a core API layer and an API facade engine. This concept resolves these issues by facilitating modular development, dynamic user interface customization, and seamless interaction with external systems, significantly improving platform adaptability and usability.

The disclosed concepts can leverage the combined functionalities of MFEs, a centralized marketplace, a core API layer, and an API facade engine to deliver a technical improvement over traditional systems. By enabling dynamic translation of the core API layer to conform to multiple competing API standards, the concept ensures interoperability and reduces the need for redundant APIs, directly addressing the technical complexities of fragmented standards. Additionally, the modular architecture enhances the functioning of financial services platforms by reducing downtime, accelerating development cycles, and enabling real-time scalability. Together, these features represent a specific improvement to computer systems and networks by streamlining platform operations, enhancing user engagement, and enabling flexible adaptation to evolving technological and regulatory requirements.

The disclosed embodiments provide a technical solution to the problem of incompatible API standards in financial systems by implementing an API façade architecture that enables automated translation and secure communication between different financial API formats. This can be accomplished through specific technical implementations combining one or more of: (1) an AI-powered adapter generation system that automatically creates data transformation mappings between different API standards, (2) a dynamic graph-based data transformation pipeline that processes and converts data between FDX, PSD2, and BIAN formats in real-time, (3) a multi-layered security architecture integrating OAuth, OIDC, and FAPI protocols, and (4) a sophisticated runtime processing system with dedicated modules for routing, rate limiting, and request handling. This technical architecture represents a practical application to computer functionality by enabling previously incompatible financial systems to communicate seamlessly while maintaining security and data integrity across different API standards.

Further elaborations, nuances, and applications of systems utilizing micro frontends, as described herein, are detailed in the following U.S. Patent Applications: U.S. patent application Ser. No. 17/663,572, filed on May 16, 2022, entitled “Micro Frontend (MFE) Contextual Experiences”; U.S. patent application Ser. No. 18/329,699, filed on Jun. 6, 2023, entitled “Individualized Contextual Experiences”; U.S. patent application Ser. No. 18/329,749, filed on Jun. 6, 2023, entitled “Micro-frontend Composition and Polymorphism”; U.S. patent application Ser. No. 18/333,222, filed on Jun. 12, 2023, entitled “Hub for Micro Front-End Service”; and U.S. patent application Ser. No. 18/519,707, filed on Nov. 27, 2023, entitled “Omni-Channel Micro Frontend Control Plane.” The content, teachings, and disclosures of the aforementioned patent applications are hereby incorporated by reference, to the extent that they do not conflict with the teachings presented herein.

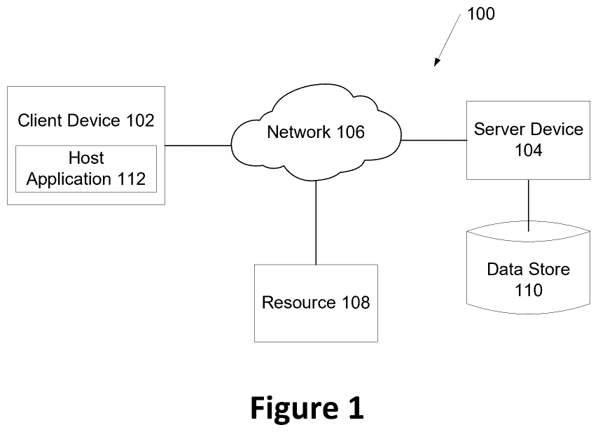

FIG. 1 illustrates a schematic of an experience platform 100 configured to generate, manage, and integrate API facades within a financial services platform. The experience platform 100 can include one or more client devices 102, operatively connected to a server device 104 via a network 106. The client device 102 can host a developer-facing interface, referred to as a host application 112, which can facilitate the selection, configuration, and deployment of API facades. The host application 112 may be accessed through a web portal or deployed as a standalone application, offering developers tools such as configuration wizards, pre-built templates, and schema definition interfaces for generating API facades. This ensures that the API facades conform to predefined system requirements and are compatible with multiple API standards, such as FDX, BIAN, and PSD2, enabling seamless interoperability between financial services products and third-party platforms.

In some embodiments, the server device 104 can be connected to a data store 110, which can securely store various types of data necessary for the development, operation, and regulatory compliance of the API facades. This data can include user interaction logs, transaction records, financial information, and metadata specific to individual API facades. The data store 110 can also manage compliance-related information, such as audit logs and security protocols, ensuring regulatory adherence while maintaining the confidentiality and integrity of sensitive customer data. By centralizing this information, the platform facilitates seamless integration of API facades and enables real-time monitoring and enforcement of data access policies.

The client device 102 can interact with the server device 104 to perform tasks such as generating API facades, configuring security and authentication protocols, and interfacing with a core API layer. The server device 104 can provide computational resources to process data and execute operations, including translating the functionalities exposed by the core API layer into formats compatible with one or more competing API standards. This translation can be handled by an API facade engine, which can be part of the control messaging facility within the server device 104. The API facade engine enables interoperability by dynamically mapping data structures, authentication schemes, and communication protocols to meet the requirements of external platforms without requiring direct modifications to the core API layer.

The network 106 can act as the communication backbone for real-time data exchange between the client device 102 and the server device 104. Through the network 106, API facades can dynamically request and receive data from various components of the system, including backend financial services, regulatory systems, and third-party applications. The network 106 ensures that API facades can function as standardized interfaces for financial services, enabling developers to integrate platform functionalities into a wide range of software environments.

Additionally, in some embodiments, the experience platform 100 can include one or more resources 108 to enhance the development and deployment of API facades. These resources 108 can encompass subscription services, machine learning algorithms, and external data services that provide real-time feeds of economic indicators, asset prices, or other financial metrics. The one or more resources 108 can also contribute to the platform's runtime API service and a containerized service mesh ecosystem, enabling the deployment and hosting of API facades across diverse environments. The API facades can be stored in a centralized developer portal, which can facilitate access control and integration into the financial services platform. From this developer portal, API facades can be dynamically composed and deployed to support specific user roles, business logic, and regulatory compliance requirements.

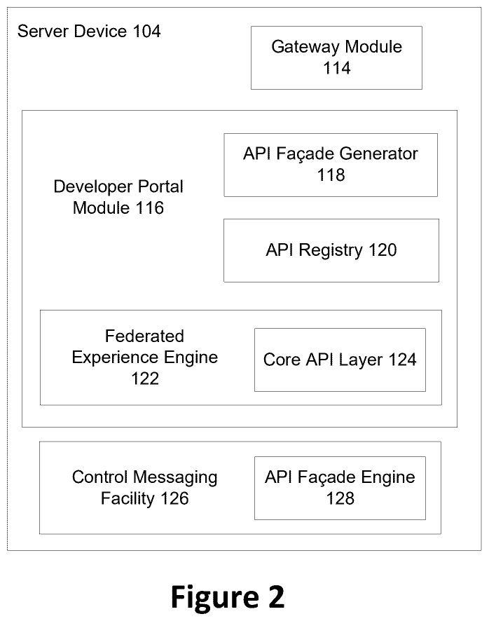

FIG. 2 illustrates an embodiment of the server device 104 within the experience platform 100, highlighting components that enable the generation, storage, management, and integration of API facades. As depicted in FIG. 2, the server device 104 can include a gateway module 114, a developer portal module 116, and a control messaging facility 126, each contributing distinct functionalities to support the modular, scalable, and interoperable operation of API facades. In operation, these components can work in tandem to facilitate the creation of at least one API facade aligned with specific use cases and standards, the storage and versioning of API facades in a centralized developer portal, and the seamless integration of API facades into financial services platforms via a core API layer.

With continued reference to FIG. 2, the gateway module 114 can be configured to manage user identification, access control, and entitlements, enabling secure and authorized interactions with the experience platform 100. The gateway module 114 can ensure that users and third-party platforms are authenticated before gaining access to the platform's features, including financial products, services, and API facades. By implementing robust security protocols, the gateway module 114 can safeguard sensitive financial data and maintain the integrity and reliability of the system while adhering to security and regulatory standards.

To achieve secure authentication, in some embodiments, the gateway module 114 can be configured to employ various methods, such as multi-factor authentication and biometric verification. In some embodiments, these authentication mechanisms can involve combinations of credentials, such as passwords, device-based tokens, and biometric data, including fingerprints or facial recognition. Such configurations can help mitigate the risk of unauthorized access, ensuring that only verified users can interact with the platform. Additionally, the gateway module 114 can screen authentication attempts to detect and block potentially fraudulent or suspicious logins. By managing customer identity verification and authentication protocols, the gateway module 114 can enhance the overall security posture of the platform.

Furthermore, the gateway module 114 can be configured to manage access permissions by assigning and enforcing role-based entitlements. In some embodiments, the gateway module 114 can determine which users are authorized to access specific API facades or functionalities based on their roles within the organization. For example, a user tasked with financial analysis may be granted access to API facades related to reporting and analytics, while another user focused on transaction processing may be allowed to interact with API facades specific to payment workflows. The gateway module 114 can maintain detailed records of these roles and permissions, ensuring that users are restricted to only the resources and capabilities necessary for their tasks, thereby ensuring compliance with organizational policies and regulatory requirements while simultaneously providing a secure and tailored user experience.

The developer portal module 116 can be configured to serve as a centralized repository for managing and accessing API facades, developer tools, and related resources within the financial services platform. Accessible through the host application 112, the developer portal module 116 can enable users to browse, select, and integrate API facades tailored to specific needs, facilitating the seamless incorporation of financial products and services into both internal and third-party platforms. To support these functionalities, the developer portal module 116 can include an API facade generator 118 and an API registry 120. Additionally, in some embodiments, the developer portal module 116 can provide a federated experience engine 122, which can include a core API layer 124 to provide a cohesive framework for modular development, deployment, and management of API facades.

The API facade generator 118 can be configured to create API facades as modular, standardized components that integrate seamlessly into larger applications. Each API facade can be designed to support a specific function, such as enabling financial transactions, retrieving account information, or processing payments according to regulatory and operational requirements. By allowing API facades to operate as independent, customizable components, the API facade generator 118 can enable updates and modifications to be implemented without disrupting other parts of the application.

For example, through the host application 112, a client device 102 can interact with the API facade generator 118 to create API facades that are tailored to specific customer or organizational requirements. In some embodiments, the host application 112 can provide developers with a suite of tools, such as pre-built templates, schema configuration options, and API standardization wizards, to streamline the creation process. This setup can reduce the need for manual coding, allowing developers to efficiently design and deploy API facades. By supporting rapid API facade generation, the API facade generator 118 can improve development efficiency and accelerate the integration of personalized API interfaces into the financial services platform.

Once created, API facades can be integrated into software platforms. For instance, a financial institution can use the API facade generator 118 to create an API facade that enables secure access to real-time financial data, such as account balances or recent transactions, using a curated API endpoint that fetches only the necessary backend data. These API facades can then be embedded within third-party platforms to provide seamless and standardized access to financial services. Because API facades function independently, updates or modifications can be implemented without affecting other platform components, ensuring ongoing flexibility and scalability to meet evolving user and system demands.

The API registry 120 can be configured to serve as a centralized catalog for securely storing and managing API facades. Users, such as developers, administrators, or financial organization team members, can self-service requests to browse the API registry 120 to identify and obtain API facades supporting specific use cases. Authorized developers can access the API registry 120 to retrieve, reuse, or update stored API facades, enabling the rapid fulfillment of service requests. Each API facade in the registry can be developed in compliance with a domain-specific language to ensure standardized communication and compatibility across the platform. By providing a structured and accessible repository, the API registry 120 can reduce redundancy in development efforts and streamline the process of managing and deploying APIs.

The API registry 120 can also be configured to validate API facades against conformance criteria such as technical, design, and performance specifications. This validation process can aid in ensuring that each API facade meets the required quality and compatibility standards before deployment to support specific external integrations. By enforcing these standards, the API registry 120 can preserve system reliability and interoperability between API facades and other platform components. Additionally, the validation process can identify and resolve potential issues in API facades during development, contributing to the robustness and dependability of the overall platform and ensuring that users can fulfill their requests with confidence.

Beyond storage and validation, the API registry 120 can catalog API facades based on attributes such as functionality, usage context, and unique characteristics, enabling users to efficiently search for and retrieve API facades that meet specific project or workflow requirements. For example, users can identify API facades configured to perform specific tasks, such as initiating payments, managing entitlements, or facilitating secure data sharing with third-party systems. Furthermore, the API registry 120 can support the combination of multiple API facades to create complex API-driven workflows, enhancing the versatility of the platform and enabling tailored integrations.

The federated experience engine 122 can retrieve API facades from the API registry 120 and orchestrate their composition and delivery across multiple communication channels, including web portals, mobile applications, and embedded third-party platforms. In supporting self-service requests, the federated experience engine 122 can assemble API facades into integrated experiences, ensuring that the assembled components meet the requirements of specific use cases, such as account balance sharing or instant payment capabilities. By managing the interaction between API facades and adapting their behavior to specific channels, the federated experience engine 122 can maintain consistent functionality, user engagement, and responsiveness, enabling seamless fulfillment of embedded experience requests.

In certain embodiments, the federated experience engine 122 can define one or more APIs to facilitate the registration of newly created API facades within the API registry 120. These APIs can enforce compliance with established system standards, including design specifications, performance benchmarks, and compatibility requirements. By streamlining the registration process and ensuring conformity to these standards, the federated experience engine 122 can maintain the reliability and integrity of the platform while promoting the efficient integration of new API facades, which users can then incorporate into their requested embedded experiences.

The federated experience engine 122 can also support personalized user experiences by adjusting API facade interactions based on user roles, identity data, entitlements, and consent settings. For example, the federated experience engine 122 can prioritize the display of API facades relevant to a specific user's workflow, such as administrative tools for managing connected users or APIs for embedding financial capabilities in partner platforms. Additionally, the federated experience engine 122 can enable API facades to integrate with the control plane, facilitating advanced functionalities such as state transitions, activity tracking, deep linking, and feedback mechanisms. By ensuring that API facades meet system requirements and are assembled in alignment with user requests, the federated experience engine 122 enables the efficient delivery of tailored, embedded experiences, enhancing platform performance and user satisfaction.

The core API layer 124, which can be integrated into the federated experience engine 122, can be configured to expose the functionalities of the financial services platform as a standardized interface. The core API layer 124 can serve as a mechanism through which API facades access backend services and interact with external systems. By offering a centralized, consistent approach to API management, the core API layer 124 can streamline communication between API facades and the underlying platform infrastructure, enhancing modularity and simplifying integration.

In this manner, the core API layer 124 can standardize access to backend functionalities, such as retrieving account balances, processing financial transactions, and fetching real-time economic data. This standardization can aid in ensuring that API facades can efficiently utilize backend services without requiring redundant or bespoke APIs, reducing development complexity and improving the scalability of the platform. By acting as a bridge between API facades and backend systems, the core API layer 124 can support modular development and foster a streamlined ecosystem.

In addition to facilitating internal integration, the core API layer 124 can support interoperability with external systems, enabling API facades to function seamlessly across diverse environments. By exposing curated and secure APIs, the core API layer 124 ensures compliance with industry standards and regulatory requirements while maintaining adaptability to evolving technological and user demands.

The control messaging facility 126 can be configured to coordinate communication between components of the experience platform 100, ensuring consistent interactions across multiple communication channels. By standardizing communication protocols and message formats, the control messaging facility 126 can maintain data integrity and enable seamless interoperability among API facades and other system elements.

In some embodiments, the control messaging facility 126 can include tools for queuing, prioritizing, and routing messages based on predefined rules and contextual requirements. These tools can direct messages to specific components, such as API facades or the federated experience engine 122, ensuring accurate delivery and efficient workflows. By coordinating message exchanges with minimal latency, the control messaging facility 126 can enhance the efficiency of communication processes between components within the platform.

Additionally, by facilitating cross-channel communication, the control messaging facility 126 can ensure that actions or state transitions initiated on one channel are reflected across other channels. For example, if a user completes a transaction on a web interface, the control messaging facility 126 can propagate this state change to the corresponding mobile interface, maintaining a consistent and interconnected user experience across devices. This cross-channel synchronization can aid in ensuring that the experience platform 100 delivers a cohesive and responsive experience, enabling users to interact with the system seamlessly, regardless of their chosen access point.

Another component of the control messaging facility 126 is the API façade engine 128, which can be configured to dynamically translate the functionalities exposed by the core API layer 124 to align with one or more of a plurality of competing API standards. These standards, which may include FDX, BIAN, PSD2, or other industry-specific protocols, often differ in terms of data formats, authentication mechanisms, and interaction requirements. The API façade engine 128 serves as an intermediary, enabling external systems and third-party platforms to interact with the platform's services in a manner consistent with their respective API standards.

The API façade engine 128 can employ translation rules, algorithms, and mapping configurations to adapt the standardized functionalities of the core API layer 124 to meet the specific requirements of external systems. For instance, the API façade engine 128 can convert data formats, adjust protocol parameters, or implement authentication workflows needed to comply with a particular API standard. By performing these dynamic translations, the API façade engine 128 ensures that external systems can access and interact with the platform's services reliably, irrespective of the underlying technical differences between APIs.

Centralizing API translation tasks within the API façade engine 128 allows the control messaging facility 126 to streamline communication management across the platform. This centralized approach ensures that all API interactions adhere to the required protocols and formats while maintaining the reliability and integrity of the system. Additionally, by consolidating API translation within a single engine, the platform can reduce redundancy and enhance scalability, enabling it to support evolving industry standards and diverse integration requirements effectively.

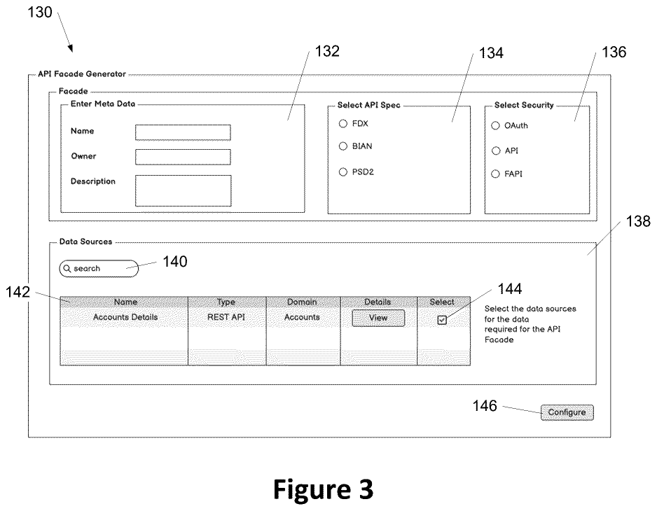

FIG. 3 illustrates an embodiment of a user interface 130, which can be configured to enable client users, developers, and team members to browse, request, and fulfill product requests for their respective companies in a self-service, automated manner. The user interface 130 can provide an interactive tool for specifying metadata, API standards, security configurations, and data source requirements for selected API facade products. The interface supports a range of embedded experiences and modalities, enabling users to tailor API facades to meet operational, regulatory, and business needs, including embedding products via SDK/API integrations, integrating API facades within partner systems through the control plane and experience platform, and utilizing the user interface in various portals, such as a developer portal, a commercial client portal, an internal servicing portal, and marketing platforms targeting prospective users.

As depicted, in some embodiments, a metadata interface portion 132 can be configured to accept general information about an API facade product selected for integration. The metadata interface portion 132 can include fields for entering a product name, owner, and description. For example, client developers may use the name field to assign a unique identifier to an instant payment API facade for easy reference, while team members might use the owner field to specify responsibility for managing the API facade within the organization. The description field can provide metadata on the API facade's purpose or operational context, such as its use for initiating instant payments or managing account balances, which streamlines the organization and management of multiple API facades within the platform.

An API specification portion 134 can enable users to define an API standard to which the selected API facade product should conform. For instance, a developer requesting API access to integrate with external systems may select standards such as FDX (Financial Data Exchange), BIAN (Banking Industry Architecture Network), or PSD2 (Payment Services Directive 2). The API specification portion 134 may further allow users to upload or select an OpenAPI (Swagger) specification corresponding to the chosen standard, ensuring accurate conformance to industry protocols. By supporting the definition of API standards, this portion of the user interface ensures that the selected API facade aligns with the necessary protocols, data formats, and authentication requirements, enabling seamless interoperability across embedded experiences within third-party systems or internal portals.

The security selection portion 136 allows users to define security protocols for the selected API facade product, tailoring security features to meet compliance and operational needs. Options may include OAuth (Open Authorization), AIP (Advanced Identity Protection), and FAPI (Financial-grade API), with other protocols also being contemplated. For example, a client administrator could configure OAuth for secure user authentication and session management, while a developer might select FAPI for ensuring high-security standards in financial transactions. This functionality ensures that the API facades integrated into the platform or third-party systems are secure and compliant with applicable regulations.

A data source portion 138 can assist users in selecting one or more data sources for the chosen API facade product. This portion may include a search bar 140 for locating specific data sources, such as account details or transaction histories, and a data representation table 142 that organizes available data sources by attributes such as name, type, domain, and version. For instance, developers embedding financial capabilities into third-party accounting software could use the table to select data sources necessary for sharing account balance or transaction data. The data source portion 138 may further allow users to specify internal data source specifications, which the system can map and translate to the selected external API standard, such as FDX, ensuring the generated API facade correctly aligns with the required external specifications. Each row in the table may feature a select box 144, allowing users to specify data sources that align with the API facade configuration.

The user interface 130 also includes action buttons 146, which allow users to perform various actions related to API facade requests and customization. For example, a “configure” button can enable users to modify detailed parameters, such as field mappings or API behaviors, supporting the creation of tailored embedded experiences. A client team member, for instance, could use this functionality to adjust security rules or map specific data fields to align with a partner platform's requirements. These actions facilitate greater flexibility and precision in fulfilling self-service API facade requests.

Additional action buttons not explicitly depicted in FIG. 3 are also contemplated. For example, a “preview” button could simulate the API facade's configuration, allowing users to confirm its behavior before deployment. A “validate” button could ensure the specified configurations comply with system compatibility and regulatory requirements.

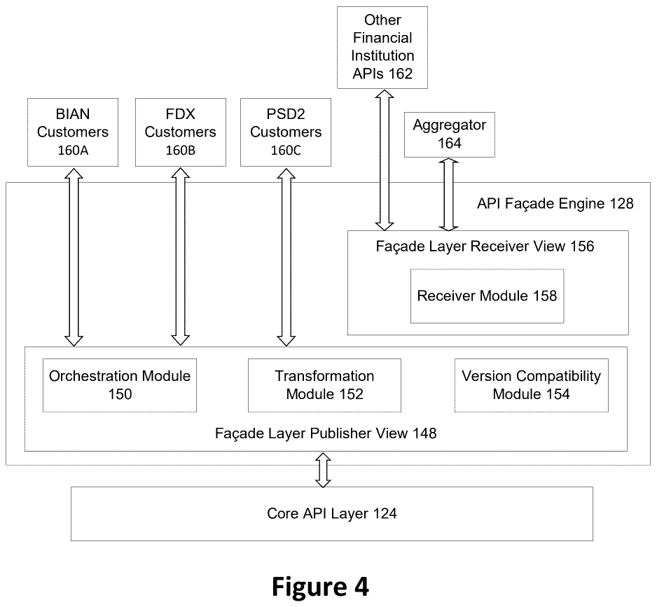

FIG. 4 illustrates an embodiment of the API façade engine 128 of FIG. 2 in greater detail, providing a high-level representation of its internal components and their respective functions. The API façade engine 128 is depicted as including two primary layers: a façade layer publisher view 148 and a façade layer receiver view 156, each configured to interact with external and internal systems. These layers facilitate the transformation, orchestration, and compatibility of APIs to meet diverse industry standards and requirements, ensuring seamless integration across financial services platforms.

In some embodiments, the façade layer publisher view 148 can be configured to manage outgoing API interactions. Within the façade layer publisher view 148, an orchestration module 150 can coordinate API requests and responses, ensuring that data flows between the core API layer 124 and external systems are efficiently managed. The orchestration module 150 may also implement prioritization and routing rules to optimize performance when handling concurrent API requests.

The transformation module 152 within the façade layer publisher view 148 can modify API data formats, protocols, or authentication mechanisms to conform to external industry standards. For example, the transformation module 152 can convert API attributes into formats compliant with OpenAPI (Swagger) for REST-based APIs, SOAP for legacy systems, or GraphQL schema where applicable. This ensures compatibility with external financial service providers, such as BIAN customers 160A, FDX customers 160B, and PSD2 customers 160C. By dynamically adapting API structures and authentication protocols, the transformation module 152 facilitates interoperability while preserving data integrity and compliance with applicable regulations.

Additionally, the version compatibility module 154 in the façade layer publisher view 148 can ensure that API facades align with the versioning requirements of external customers or systems. For instance, the version compatibility module 154 can support backward compatibility for legacy versions of APIs, enabling older client systems to interact with updated services. The module can also dynamically adapt new API features to comply with the constraints of older system versions, reducing integration errors and enhancing system flexibility.

The façade layer publisher view 148 can be configured to interact with the core API layer 124, which resides outside the API façade engine 128. For example, in some embodiments, the core API layer 124 can expose underlying platform functionalities, serving as the foundation upon which the API façade engine 128 operates. The façade layer publisher view 148 enables the tailored distribution of API facades, ensuring that published API specifications are written in the appropriate industry-standard notation, such as OpenAPI Swagger for RESTful APIs, SOAP specifications for legacy integrations, and GraphQL schemas where applicable. This approach allows external entities, including BIAN customers 160A, FDX customers 160B, and PSD2 customers 160C, to seamlessly consume APIs using formats that align with their existing systems.

The façade layer receiver view 156 can be configured to manage incoming API interactions. A receiver module 158 within the façade layer receiver view 156 can process and validate API requests received from external systems, such as financial institutions 162 and aggregators 164. The receiver module 158 can ensure that incoming API requests adhere to platform security policies and data integrity requirements before being processed. Additionally, the receiver module 158 can route incoming API calls to the appropriate internal components, facilitating secure and efficient API processing. By supporting multiple API specifications for inbound requests, the façade layer receiver view 156 enables seamless integration with third-party financial platforms while maintaining compliance with industry security standards.

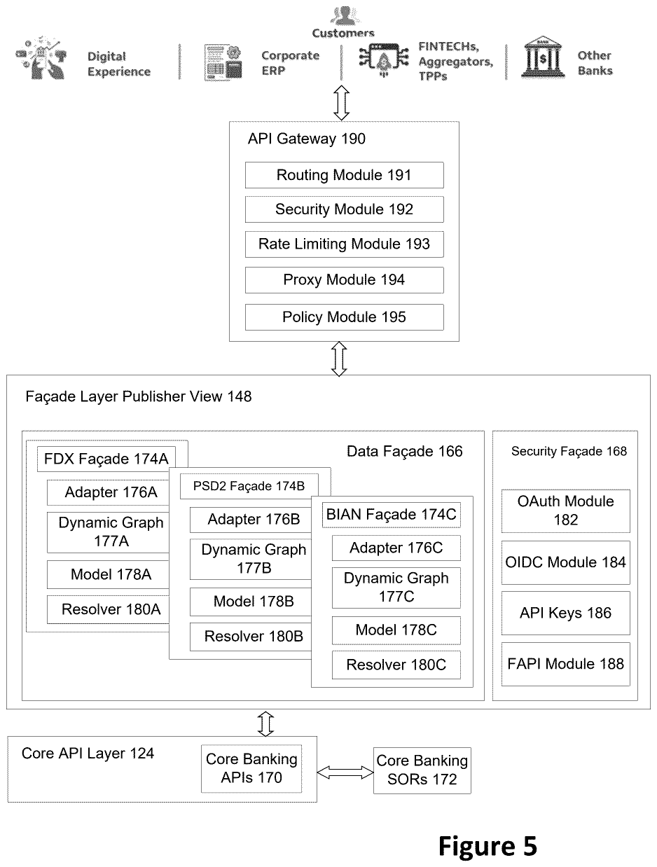

FIG. 5 illustrates an interconnection between the core API layer 124 and the façade layer publisher view 148, emphasizing their structural components and the manner in which they cooperate to deliver secure and efficient API functionalities to external systems.

The core API layer 124 can include core banking APIs 170 which can communicate with the core banking systems of record (SORs) 172. In embodiments, the core banking APIs 170 can provide access to banking functionalities, such as account management and transaction processing, while the core banking SORs 172 can store data, including account details, transaction records, and other operational information. The core API layer 124 can connect to the to the façade layer publisher view 148, supplying the raw data and services that are transformed and distributed through the façade layer publisher view 148.

The façade layer publisher view 148 can include a data façade 166 and a security façade 168. The data façade 166 can be responsible for ensuring that the platform's APIs align with specific external standards, such as FDX, PSD2, and BIAN, while the security façade 168 can enforce rigorous authentication and authorization protocols to safeguard the data.

Within the data façade 166, specialized modules can correspond to a number of API standards, with this embodiment including an FDX façade 174A, a PSD2 façade 174B, and a BIAN façade 174C. Each of these facades can include an adapter module 176, a dynamic graph module 177, a model module 178, and a resolver 180. The adapter module 176 can be configured to convert internal API attributes into formats required by the respective external standard. The dynamic graph module 177 can map relationships and dependencies between API attributes dynamically, ensuring compliance with a relevant standard. The model module 178 can define and maintain schema models tailored to each external standard, while the resolver 180 can ensure efficient and accurate responses to external API requests by resolving data queries.

The security façade 168 can incorporate several modules to manage authentication and enforce security protocols, including an OAuth module 182 for token-based authentication, an OIDC (OpenID Connect) module 184 for federated identity management, API keys 186 for secure access control, and an FAPI (Financial-grade API) module 188 to ensure compliance with established financial industry applicable security standards.

As further depicted in FIG. 5, the façade layer publisher view 148 can connect to external customers through the API Gateway 190, which can be configured to enable secure and efficient interactions with various entities, including digital experiences, corporate enterprise resource planning (ERP) systems, financial technology providers (FINTECHs), aggregators, third-party providers (TPPs), and other banks.

As depicted, the API gateway 190 can include several submodules. The routing module 191 can be responsible for directing incoming API requests to the appropriate backend services or data sources. For example, the routing module 191 can aid in ensuring that requests are efficiently processed by mapping them to the correct endpoints within the platform, optimizing performance and reducing latency. The security module 192 can validate authentication credentials, such as OAuth tokens or API keys, and applies stringent access controls to protect sensitive data and maintain compliance with regulatory standards. The security module 192 can serve to ensure that only authorized users or systems can access the platform's APIs.

The rate limiting module 193 can manage the frequency of API requests, imposing limits to prevent overuse or abuse that could compromise platform stability. This functionality can aid in maintaining consistent performance by distributing server resources equitably among users and applications. The proxy module 194 can abstract the internal architecture of the platform, acting as an intermediary that simplifies integration with external systems. By masking the complexity of the backend, the proxy module 194 can enhance the usability of the APIs for third-party developers and clients.

The policy module 195 can force predefined rules governing API usage and access permissions. In embodiments, the policy module 195 can serve to ensure that API interactions align with organizational policies, regulatory requirements, and user-specific entitlements.

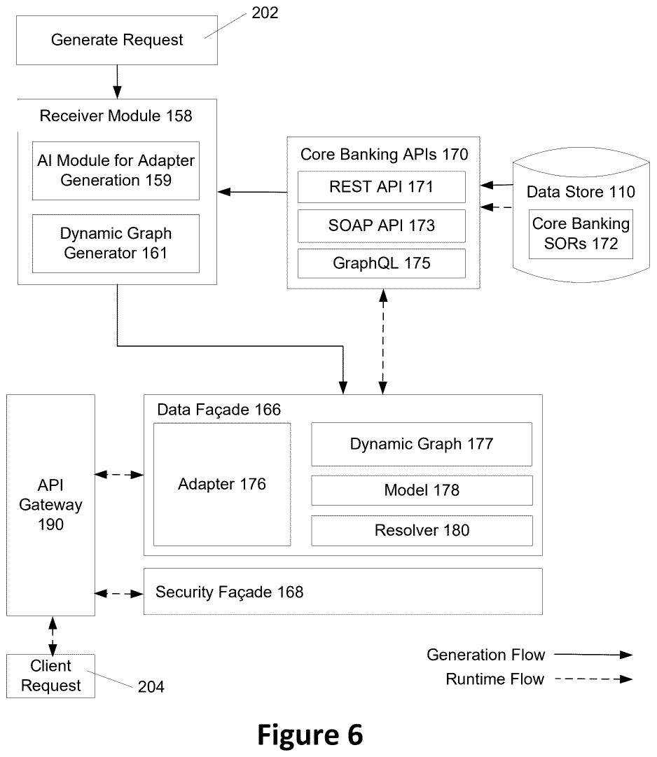

FIG. 6 provides an architecture diagram illustrating the interconnected components and process flows within the experience platform 100 for managing both product requests and client requests. In particular, FIG. 6 depicts how the receiver module 158 (as shown in FIG. 4), and data façade 166 and security façade 168 (as shown in FIG. 5) cooperate to handle these processes. FIG. 6 distinguishes between two workflows: the process flow for generating product requests, represented by a solid line, and the process flow for clients accessing embedded products, represented by a broken line. These workflows reflect the dual functionality of the experience platform 100, which supports developers and users in embedding financial products into applications while simultaneously allowing clients to interact with these products to access their account details or perform transactions.

The process for generating product requests begins with a user-initiated action at step 202. This request, originating from a developer or administrator, could be for integrating financial products into external platforms or applications, such as ERP systems, accounting software, or third-party portals. In some embodiments, the process flow for generating product requests can be initiated through the user interface 130, as depicted in FIG. 3. Users, including developers, client administrators, or team members, can browse, request, and configure financial products using the interactive tools provided by the user interface. For example, a user may specify desired API standards, security protocols, and data source configurations within the metadata interface portion 132 or other interactive components of the user interface 130. These inputs can initiate a product request that can be routed through the system to the receiver module 158 enabling users to engage in the product request process, supporting self-service onboarding of financial capabilities into their respective platforms while maintaining alignment with system-wide configurations.

The request at step 202 is received by the receiver module 158, which prepares the requested product for integration. In some embodiments, the receiver module 158 can include an AI module for adapter generation 159 and a dynamic graph generator 161, which can collaborate to create the components to fulfill the request, ensuring interoperability with the system's architecture and the requesting application.

The AI module for adapter generation 159 can process the input parameters from the product request. These parameters can include target API specifications, existing source API configurations, and defined security requirements. In some embodiments, the AI module for adapter generation 159 can use one or more machine learning algorithms to analyze these inputs to generate a custom adapter module to serve as a bridge, enabling communication between the requested financial product and the external platform where it will be integrated. The AI module for adapter generation 159 can also validate compatibility with system standards and identify potential optimization opportunities, ensuring that the adapter meets both functional and security requirements for integration.

The dynamic graph generator 161 complements the AI module for adapter generation 159 by constructing the data models required for the integration. The dynamic graph generator 161 can generate graph models tailored to the request, automatically combines them into cohesive frameworks, and produces resolvers to handle dynamic data queries.

As depicted, the dynamic graph generator 161 can pull data from the core banking APIs 170—including REST APIs 171, SOAP APIs 173, and GraphQL 175—and the core banking systems of records (SORs) 172 stored in the data store 110. REST APIs 171 provide a standardized, stateless protocol for interacting with resources over HTTP. SOAP APIs 173 use a more rigid messaging protocol designed for secure and reliable transactions. GraphQL 175 enables clients to precisely query the data they need, improving efficiency and flexibility in dynamic applications.

After processing the request, the receiver module 158 outputs the prepared adapter and data models to the data façade 166. The data façade 166 facilitates the next steps of integration, ensuring that the generated product is ready for deployment into the external platform or application.

The process flow for client interactions can begin with a client-initiated request at step 204. The system can be configured to allow a client, such as an end-user, to access embedded financial products to perform actions like viewing account balances, approving payments, or retrieving transactional details. Requests can be routed through the API Gateway 190, which can function as a centralized access point for external interactions. The API Gateway 190 can interface with both the data façade 166 and the security façade 168 to process the request. Within the data façade 166, various modules can work together to interpret and fulfill the request. An adapter module 176 can map client requests to the appropriate backend services, while a dynamic graph module 177 can manage efficient data flow by generating and handling dynamic graphs. A model module 178 can standardize data formats and structures to align with platform requirements, and a resolver 180 can interact with the core banking APIs 170 and core banking SORs 172 to retrieve data or execute requested actions.

The security façade 168 can ensure that all client interactions are authenticated and authorized before processing. The security façade 168 can support various security protocols, such as OAuth, OIDC, and FAPI, to validate client credentials, enforce access policies, and protect sensitive financial data from unauthorized access. By integrating with the data façade 166, the system can ensure that client requests are securely managed. For example, while the data façade can retrieve and process necessary account details, the security façade 168 can validate the user's credentials and ensure compliance with pre-defined security policies, which can enable secure and efficient handling of client requests, aligning with regulatory and organizational standards.

The dual workflows illustrated in FIG. 6 can showcase the system's capacity to accommodate both product requests and client requests within a unified platform. Developers can use the receiver module 158 to generate product requests, tailoring financial products for integration into external applications. At the same time, clients can access these embedded products through the API Gateway 190, leveraging the data and security façades to perform account-related tasks. Further, the experience platform 100 can be configured to support the creation of versatile financial products while ensuring their secure deployment in diverse environments.

The experience platform 100 can operate with flexibility, allowing these workflows to function in parallel or independently, depending on specific use cases. For instance, a financial institution can use the experience platform 100 to provide developers with tools to embed instant payment capabilities into third-party platforms, while enabling clients to directly access those capabilities through their applications, thereby enabling both developers and clients to interact with financial products in a streamlined and secure manner.

The process flow for client interactions can begin with a client-initiated request at step 204. The client can, for example, be an end-user accessing embedded financial products to view account balances, approve payments, or retrieve transactional details. The request is routed through the API Gateway 190, which acts as a centralized access point for external interactions. The API Gateway 190 interfaces with both the data façade 166 and the security façade 168 to handle the request. The data façade 166 can include any one of several standard façades, such as an FDX façade 174A, a PSD2 façade 174B, or a BIAN façade 174C (as depicted in FIG. 5), depending on the specific protocol or data standard required. Within the selected façade, specialized modules work together to interpret and fulfill the request. For instance, the adapter module 176 can map client requests to the appropriate backend services, the dynamic graph module 177 can generate and manage dynamic graphs to ensure efficient data flow, the model module 178 can standardize data formats and structures to align with platform requirements, and the resolver 180 can interact with the core banking APIs 170 and systems of record (SORs) 172 to retrieve necessary data or execute requested actions, enabling the system to handle diverse request types across multiple channels while maintaining efficiency and consistency.

The security façade 168 plays a crucial role in ensuring that all client interactions are authenticated and authorized before proceeding. It supports a variety of security protocols, such as OAuth, OIDC, and FAPI, to validate client credentials, enforce access policies, and protect sensitive financial data from unauthorized access. The integration of the data façade 166 and the security façade 168 ensures that every client request is handled securely and efficiently, adhering to regulatory and organizational standards. For example, while the data façade retrieves and processes the necessary account details, the security façade validates the user's credentials and ensures that the requested operation complies with pre-defined security policies.

The dual workflows depicted in FIG. 6 demonstrate the system's ability to accommodate both product requests and client requests within a unified platform. Developers can seamlessly generate product requests using the receiver module 158, ensuring that financial products are tailored for integration into external applications. Simultaneously, clients can access these embedded products through the API Gateway 190, leveraging the data and security façades to perform account-related tasks. This interconnected architecture not only supports the creation of versatile financial products but also facilitates their secure and efficient deployment in diverse environments.

The flexibility of the architecture allows these workflows to operate in parallel or independently, depending on the use case. For instance, a financial institution might use the system to provide developers with tools to embed instant payment capabilities into third-party platforms while enabling clients to access those capabilities directly through their applications. By combining advanced adapter generation, dynamic graph processing, and robust security measures, the system ensures that both developers and clients can interact with financial products in a streamlined and secure manner.

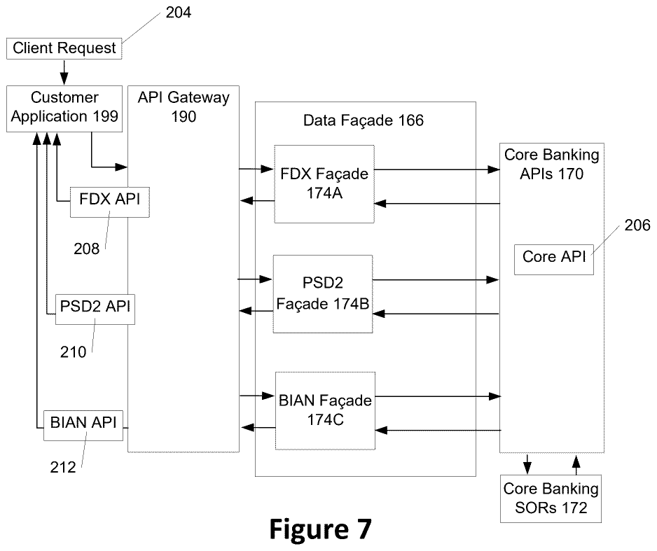

FIG. 7 illustrates an architecture diagram depicting the interconnection of the API Gateway 190, the data façade 166, and the core banking APIs 170, illustrating how the system can adapt one or more core banking APIs into specific standards, such as FDX, PSD2, or BIAN. This capability allows clients to interact with core banking functionalities through standardized APIs, ensuring interoperability and compliance with industry standards. The adaptation process leverages the modular architecture of the data façade 166 and its specialized façades, including the FDX façade 174A, the PSD2 façade 174B, and the BIAN façade 174C.

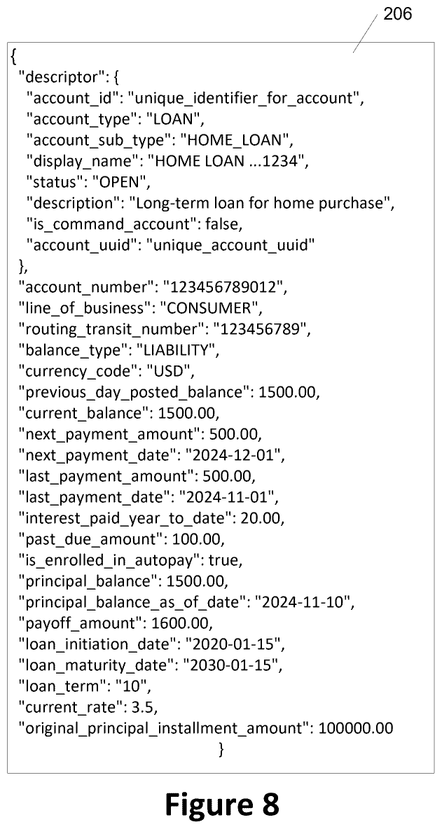

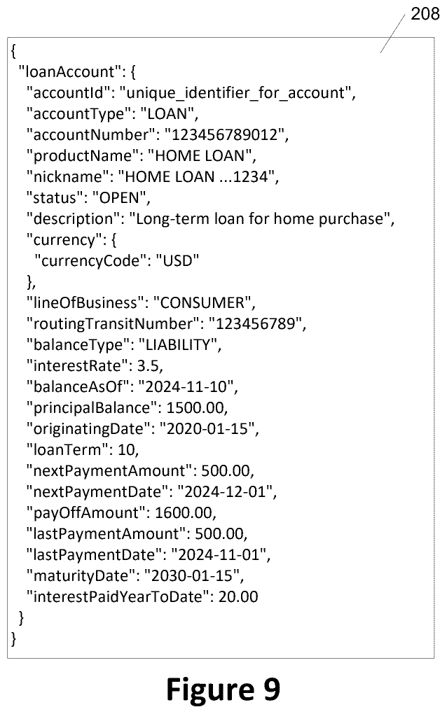

Adaptation to the FDX standard begins with a client request at step 204. For example, a client accessing financial services through a customer application 199 may submit an API request to retrieve account details or transactional data. This request can be routed to the API Gateway 190, which can act as a centralized access point to perform initial security checks. Upon validation, the API Gateway 190 can communicate the request to the FDX façade 174A within the data façade 166. The FDX façade 174A can perform additional façade-specific security checks to ensure compliance with FDX requirements and then forward the request to the core banking APIs 170. The core banking APIs 170 can interact with the core banking SORs 172, to retrieve the necessary data to fulfill the request. Upon receipt of the data from the core banking SORs 172, the core banking APIs 170 can prepare a response in the platform's native core banking API format. An example of the core banking API format 206 is depicted in FIG. 8. The FDX façade 174A adapts the core banking API response into the FDX-standard API response 208, as depicted in FIG. 9. The FDX-standard API response 208 is communicated back to the customer application 199, enabling the client to use the requested data in the standardized format.

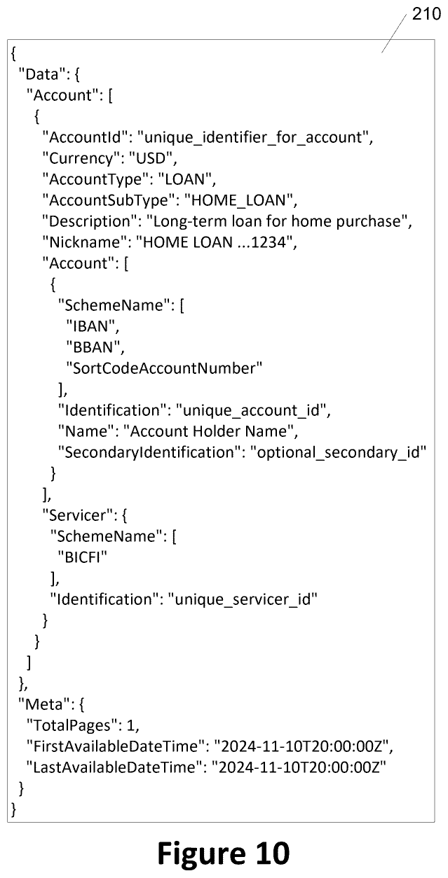

A similar process occurs for adaptation to the PSD2 standard. A client request, initiated at step 204 via the customer application 199, is routed through the API Gateway 190, where initial security checks are performed. The request is then directed to the PSD2 façade 174B within the data façade 166, which applies PSD2-specific security protocols and forwards the request to the core banking APIs 170. The core banking APIs 170, as in the previous workflow, interact with the core banking SORs 172 to retrieve the requested data. Once the data is retrieved and formatted into the core banking API format, the PSD2 façade 174B adapts the response into the PSD2-standard API response 210, as depicted in FIG. 10. The PSD2-standard API response 210 is returned to the customer application 199, providing the client with the requested data in compliance with PSD2 requirements.

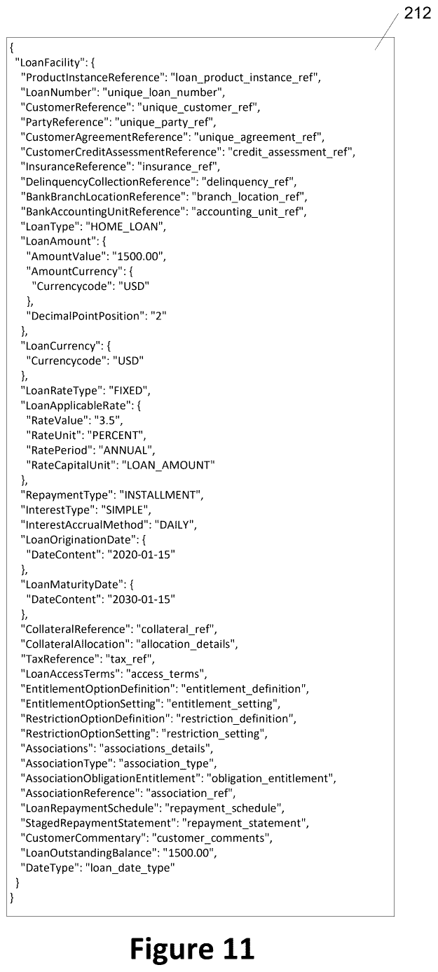

The system also supports adaptation to the BIAN standard. At step 204, a client request initiated via the customer application 199 is validated by the API Gateway 190 and subsequently routed to the BIAN façade 174C within the data façade 166. The BIAN façade 174C applies BIAN-specific security measures and transmits the request to the core banking APIs 170. The core banking APIs 170 access the core banking SORs 172 to retrieve the relevant data and prepare an API response in the platform's native format. The BIAN façade 174C then converts this response into the BIAN-standard API response 212, as depicted in FIG. 11. At step 210, the BIAN-standard API response is communicated back to the customer application 199, enabling the client to utilize the requested data in the standardized BIAN format.

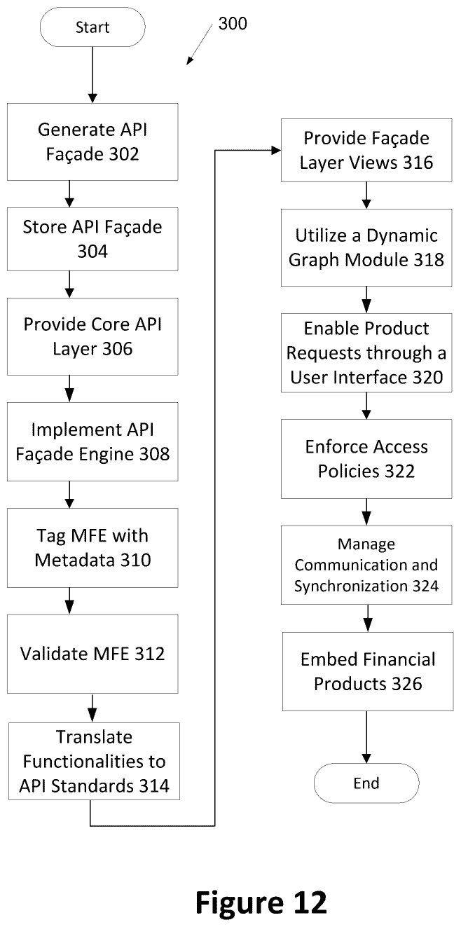

FIG. 12 depicts a method 300 for managing modular components within the experience platform 100. It should be understood that the steps recited in the method 300 can be performed in any order, including simultaneously, provided that the method remains operable. Additionally, it should be understood that the apparatus and methods described herein may include any subset of the described steps, provided that the functionality is retained.

At step 302, the method 300 generates at least one API façade configured to perform at least one function within the financial services platform. The API façade is developed using a domain-specific language associated with a predefined system framework, enabling compatibility with platform requirements. At step 304, the method 300 stores the generated API façade in a centralized marketplace, which facilitates access and integration of the API façade into the financial services platform.

At step 306, the method 300 provides a core API layer configured to expose functionalities of the financial services platform. The core API layer enables interaction between the API façade and external systems or components. At step 308, the method 300 implements an API façade engine operably coupled to the core API layer. The API façade engine translates the functionalities exposed by the core API layer to conform to at least one of a plurality of competing API standards, such as FDX, PSD2, or BIAN.

At step 310, the method 300 can tag the API façade stored in the centralized marketplace with metadata. This tagging can enhance discoverability and reuse of the API façade across multiple portals associated with the financial services platform. In some embodiments, this step may be optional, depending on the specific requirements of the implementation.

At step 312, the method 300 can validate the API façade against conformance criteria, including technical specifications, design guidelines, and performance benchmarks, to ensure compatibility with the predefined system framework. This validation step may also be optional in some embodiments, based on the implementation requirements.

At step 314, the method 300 translates the functionalities exposed by the core API layer to conform to specific API standards using the API façade engine. This step ensures interoperability across diverse external systems. At step 316, the method 300 provides façade layer views, including a publisher view for adapting functionalities for external users and a receiver view for processing incoming API requests from external systems.

At step 318, the method 300 utilizes a dynamic graph module within the API façade engine to generate dynamic graphs for data retrieval and mapping. These dynamic graphs streamline interactions between the core API layer and external systems, enhancing data flow efficiency.

At step 320, the method 300 enables users to browse, request, and fulfill product requests through interactive tools within a user interface. These tools allow users to access APIs, manage user entitlements, and establish data sharing connections, facilitating a seamless user experience.

At step 322, the method 300 enforces access policies to ensure secure interactions between external systems and the financial services platform. This includes validating client credentials and supporting security protocols, such as OAuth, OIDC, and FAPI, through a security façade within the API façade engine.

At step 324, the method 300 manages communication and synchronization between APIs and external systems. This step can be performed through a control plane operably connected to the centralized marketplace and the API façade engine, ensuring consistent functionality and data exchange across the platform.

At step 326, the method 300 enables the generated API façades to embed financial products within third-party platforms, including client applications, developer portals, and internal servicing systems. Embedding can be achieved by dynamically adapting the API façade to user roles, entitlements, and preferences, thereby supporting personalized and efficient interactions.

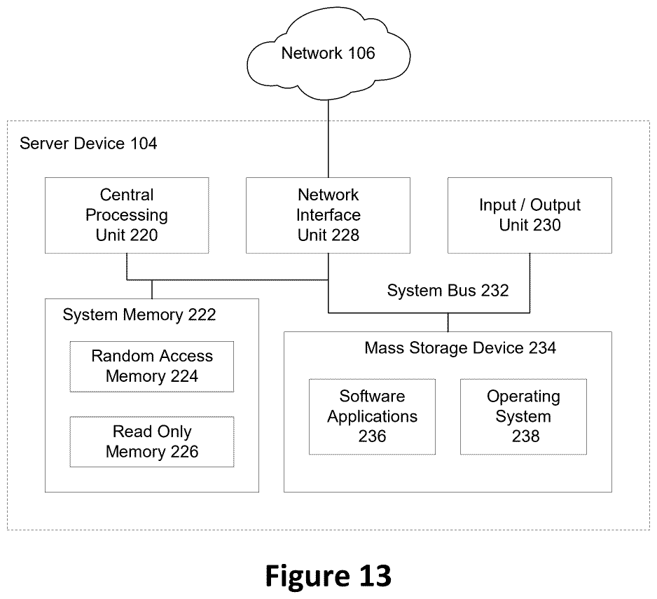

As illustrated in the embodiment of FIG. 13, the example server device 104, which provides the functionality described herein, can include at least one central processing unit (CPU) 166, a system memory 174, and a system bus 232 that couples the system memory 174 to the CPU 220. The system memory 174 includes a random access memory (RAM) 176 and a read-only memory (ROM) 178. A basic input/output system containing the basic routines that help transfer information between elements within the server device 104, such as during startup, is stored in the ROM 226. The server device 104 further includes a mass storage device 234. The mass storage device 234 can store software instructions and data. A central processing unit, system memory, and mass storage device similar to that shown can also be included in the other computing devices disclosed herein.

The mass storage device 234 is connected to the CPU 220 through a mass storage controller (not shown) connected to the system bus 232. The mass storage device 234 and its associated computer-readable data storage media provide non-volatile, non-transitory storage for the server device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (DVDs), other optical storage media, magnetic cassettes, magnetic tape, magnetic disk storage or other magnetic storage devices, or any other medium which can be used to store the desired information and which can be accessed by the server device 104.

According to various embodiments, the server device 104 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server device 104 may connect to network 106 through a network interface unit 228 connected to the system bus 232. It should be appreciated that the network interface unit 228 may also be utilized to connect to other types of networks and remote computing systems. The server device 104 also includes an input/output controller 230 for receiving and processing input from a number of other devices, including a touch user interface display screen or another type of input device. Similarly, the input/output controller 230 may provide output to a touch user interface display screen or other output devices.

As mentioned briefly above, the mass storage device 234 and the RAM 224 of the server device 104 can store software instructions and data. The software instructions include an operating system 238 suitable for controlling the operation of the server device 104. The mass storage device 234 and/or the RAM 224 also store software instructions and applications 236, that when executed by the CPU 220, cause the server device 104 to provide the functionality of the server device 104 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system, comprising:
at least one processor; and
non-transitory computer-readable storage storing instructions that, when executed by the at least one processor, cause the system to:
generate at least one Application Programming Interface (API) facade configured to expose a subset of platform functionalities in accordance with predefined industry standards, wherein the at least one API facade is developed using a domain-specific language associated with a predefined system framework;
store the at least one API facade in a centralized developer portal, the centralized developer portal enabling access and integration of the at least one API facade into external systems and applications;
provide a core application programming interface (API) layer, wherein the core API layer is configured to expose functionalities of the platform to enable interaction between the at least one API facade and external systems and components; and
implement an API façade engine operably coupled to the core API layer, wherein the API façade engine is configured to translate the functionalities exposed by the core API layer to conform to at least one of a plurality of competing API standards.

2. The system of claim 1, wherein the centralized developer portal is configured to include metadata tagging for the at least one API facade, enabling enhanced discoverability and reuse of the at least one API facade across multiple external systems and applications.

3. The system of claim 1, wherein the centralized developer portal is further configured to validate the at least one API facade against conformance criteria, including technical specifications, design guidelines, and performance benchmarks, to aid in ensuring compatibility with the predefined system framework.

4. The system of claim 1, wherein the API façade engine is further configured to translate the functionalities exposed by the core API layer to conform to at least one of an Financial Data Exchange (FDX), Banking Industry Architecture Network (BIAN), and Payment Services Directive 2 (PSD2) standard.

5. The system of claim 1, wherein the API façade engine comprises a façade layer publisher view and a façade layer receiver view, the façade layer publisher view configured to adapt the functionalities for external users and the façade layer receiver view configured to process incoming API requests from external systems.

6. The system of claim 1, wherein the API façade engine includes a dynamic graph module configured to generate dynamic graphs for data retrieval and mapping, and wherein the dynamic graphs are used to streamline interactions between the core API layer and external systems.

7. The system of claim 1, wherein the at least one API facade is configured to enable users to browse, request, and fulfill product requests through interactive tools within a user interface, including requests to access APIs, manage user entitlements, and set up data-sharing connections.

8. The system of claim 1, wherein the API façade engine includes a security façade configured to enforce access policies, validate client credentials, and support security protocols to aid in ensuring secure interactions between external systems and the platform functionalities exposed by the core API layer.

9. The system of claim 1, further comprising a control plane operably connected to the centralized developer portal and the API façade engine, wherein the control plane is configured to manage communication and synchronization between API facades and external systems to aid in ensuring consistent functionality and data exchange.

10. The system of claim 1, wherein the at least one API facade is configured to enable embedding of financial products within third-party platforms, including client applications, developer portals, and internal servicing systems, by adapting to user roles, entitlements, and preferences.

11. A method, comprising:
generating at least one Application Programming Interface (API) facade configured to expose a subset of platform functionalities in accordance with predefined industry standards, wherein the at least one API facade is developed using a domain-specific language associated with a predefined system framework;
storing the at least one API facade in a centralized developer portal, the centralized developer portal enabling access and integration of the at least one API facade into external systems and applications;
providing a core application programming interface (API) layer, wherein the core API layer is configured to expose functionalities of the platform to enable interaction between the at least one API facade and external systems and components; and
implementing an API façade engine operably coupled to the core API layer, wherein the API façade engine is configured to translate the functionalities exposed by the core API layer to conform to at least one of a plurality of competing API standards.

12. The method of claim 11, further comprising: including metadata tagging for the at least one API facade in the centralized developer portal, enabling enhanced discoverability and reuse of the at least one API facade across multiple external systems and applications.

13. The method of claim 11, further comprising: validating the at least one API facade against conformance criteria, including technical specifications, design guidelines, and performance benchmarks, to aid in ensuring compatibility with the predefined system framework.

14. The method of claim 11, wherein implementing the API façade engine further comprises translating the functionalities exposed by the core API layer to conform to at least one of an Financial Data Exchange (FDX), Banking Industry Architecture Network (BIAN), and Payment Services Directive 2 (PSD2) standard.

15. The method of claim 11, wherein implementing the API façade engine further comprises providing a façade layer publisher view configured to adapt the functionalities for external users and a façade layer receiver view configured to process incoming API requests from external systems.

16. The method of claim 11, wherein implementing the API façade engine further comprises generating dynamic graphs for data retrieval and mapping using a dynamic graph module, wherein the dynamic graphs are used to streamline interactions between the core API layer and external systems.

17. The method of claim 11, further comprising: enabling users to browse, request, and fulfill product requests through interactive tools within a user interface, including requests to access APIs, manage user entitlements, and set up data-sharing connections.

18. The method of claim 11, wherein implementing the API façade engine further comprises enforcing access policies, validating client credentials, and supporting security protocols using a security façade to aid in ensuring secure interactions between external systems and the platform functionalities exposed by the core API layer.

19. The method of claim 11, further comprising: managing communication and synchronization between API facades and external systems using a control plane operably connected to the centralized developer portal and the API façade engine to aid in ensuring consistent functionality and data exchange.

20. The method of claim 11, wherein the at least one API facade is configured to enable embedding of financial products within third-party platforms, including client applications, developer portals, and internal servicing systems, by adapting to user roles, entitlements, and preferences.
